(19) United States
(12) Patent Application Publication
(10) Pub. No.: US 2009/0059876 A1
(43) Pub. Date: Mar. 5, 2009

(54) APPARATUS AND METHOD FOR UPDATING MAC TABLE OF LAYER-2 SWITCH IN A BROADBAND WIRELESS COMMUNICATION SYSTEM

(75) Inventors: Hyun-Ok KIM, Osan-si (KR); Min-Young AHN, Seongnam-si (KR); Se-Youn LIM, Seoul (KR); Kug SHIN, Seoul (KR)

Correspondence Address: Jefferson IP Law, LLP, 1730 M Street, NW, Suite 807, Washington, DC, 20036, US

(73) Assignee: SAMSUNG ELECTRONICS CO., LTD., Suwon-city (KR)

(21) Appl. No.: 12/194,694

(22) Filed: Aug. 20, 2008

(30) Foreign Application Priority Data
Aug. 31, 2007 (KR) 2007-0088044

(51) Int. Cl. H04B 7/00; H04Q 7/00

(52) U.S. Cl. 370/338; 370/331

(57) ABSTRACT

A broadband wireless communication system is provided. An apparatus for a Base Station (BS) comprises a controller for determining whether to accept an entry of a mobile terminal (MT) by handover from an adjacent BS, a handler for generating a message to get an L2 switch to update a Media Access Control (MAC) table, and a communicator for transmitting the message to the L2 switch.

### PRIORITY

This application claims the benefit under 35 U.S.C. §119(a) of a Korean patent application filed in the Korean Intellectual Property Office on Aug. 31, 2007 and assigned Serial No. 2007-88044, the entire disclosure of which is hereby incorporated by reference.

### BACKGROUND OF THE INVENTION

1. Field of the Invention

The present invention relates to a broadband wireless communication system. More particularly, the present invention relates to an apparatus and method for updating a Media Access Control (MAC) table of a Layer-2 (L2) switch in a broadband wireless communication system.

2. Description of the Related Art

In a wireless communication system, access network provides a Mobile Terminal (MT) access to core network, and is classified into a 1-tier and a 2-tier in accordance with a configuration of network entities. In a broadband wireless communication with a 1-tier configuration, services which are sensitive to time delay, such as Voice over Internet Protocol (VoIP) and video streaming, may be provided to an MT from a serving Base Station (BS). In that case, to ensure mobility of the MT, the broadband wireless communication system has to support a handover of an MT which is moving between BSs during a service use.

To perform a handover operation, a procedure for changing serving BS has to be done in all layers of a physical layer, a MAC layer, and an Internet Protocol (IP) layer. For instance, if BSs constituting the access network are connected through a MAC layer switch which is an L2 switch 130 as shown in FIG. 1, the operation explained below is performed in the L2 switch 130.

FIG. 1 illustrates a schematic configuration of a conventional 1-tier broadband wireless communication system.

Referring to FIG. 1, an MT 110 is connected with core network through a BS_A 120-1 and uses a service. At this time, the L2 switch 130 manages a table including information on relations between a MAC address of an MT and an output port for sending traffic to the MAC address. Herein, the table is called a MAC table. Accordingly, when downlink traffic of which a destination MAC address is the MAC address of the MT 110 is received, the L2 switch 130 detects a port corresponding to the MAC address of the MT 110 by searching the MAC table, and outputs the downlink traffic through the port. Therefore, the L2 switch 130 has to know which BS the MT 110 is connected with before the downlink traffic of which the destination MAC address is the MAC address of the MT 110 is received. It is confirmed by checking which port uplink traffic of which a source MAC address is the MAC address of the MT 110 is received through. A process for recording the source MAC address on the MAC table when the uplink traffic is received is called MAC learning.

It is assumed that the MT 110 performs handover to a BS_B 120-2 while receiving the downlink traffic. In this case, the MT 110 does not transmit uplink traffic. Accordingly, the L2 switch 130 does not recognize that the BS connected with the MT 110 is changed using MAC learning. Hence, the MAC table of the L2 switch 130 is not updated, and the L2 switch 130 would output the downlink traffic to the MT 110 through the port corresponding to the BS_A 120-1.

As stated above, in a 1-tier wireless communication system using an L2 switch, downlink traffic to an MT, which has performed handover, may not be forwarded to the MT. Therefore, a solution is needed that enables the MT to receive the downlink traffic after the handover.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for ensuring seamless traffic reception of a Mobile Terminal (MT) in a broadband wireless communication system.

Another aspect of the present invention is to provide an apparatus and method for performing handover while considering a traffic path change of an MT in a broadband wireless communication system.

Another aspect of the present invention is to provide an apparatus and method for updating a Media Access Control (MAC) table of a Layer-2 (L2) switch according to handover of an MT in a broadband wireless communication system.

In accordance with an aspect of the present invention, an apparatus for a Base Station (BS) in a wireless communication system having a 1-tier configuration and using L2 switch is provided. The apparatus includes a controller for determining whether to accept an entry of an MT by handover from an adjacent BS, a handler for generating a message to get the L2 switch to update the MAC table, and a communicator for transmitting the message to the L2 switch.

In accordance with another aspect of the present invention, an apparatus for an L2 switch connecting BSs in a wireless communication system having a 1-tier configuration is provided. The apparatus includes a communicator for receiving a MAC table update message from a BS, and a controller for updating a MAC table according to the MAC table update message.

In accordance with another aspect of the present invention, an operating method of a BS in a wireless communication system having a 1-tier configuration and using L2 switch is provided. The method includes determining whether to accept an entry of an MT by handover from an adjacent BS, generating a message to get the L2 switch to update the MAC table, and transmitting the message to the L2 switch.

In accordance with another aspect of the present invention, an operating method of a BS in a wireless communication system having a 1-tier configuration and using L2 switch is provided. The method comprises determining whether to accept an entry of an MT by handover from an adjacent BS, generating a message to get the L2 switch to update the Media Access Control (MAC) table, and transmitting the message to the L2 switch.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a schematic configuration of a conventional 1-tier broadband wireless communication system;

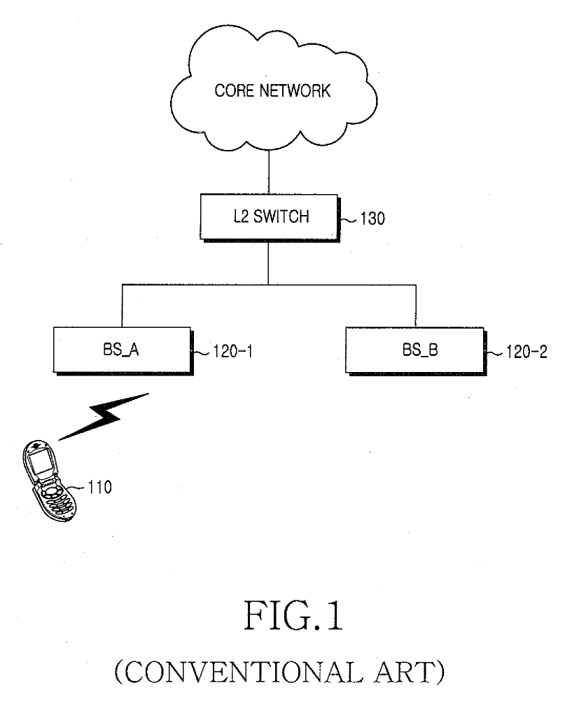

FIG. 2 illustrates a signal exchange for handover in a broadband wireless communication system according to an exemplary embodiment of the present invention;

FIG. 3 is a block diagram of a Base Station (BS) in a broadband wireless communication system according to an exemplary embodiment of the present invention;

FIG. 4 is a block diagram of a Layer-2 (L2) switch in a broadband wireless communication system according to an exemplary embodiment of the present invention;

FIG. 5 is a flowchart illustrating a MAC table update request process of a BS in a broadband wireless communication system according to an exemplary embodiment of the present invention; and

FIG. 6 is a flowchart illustrating a MAC table update process of an L2 switch in a broadband wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the exemplary embodiments described herein can be made without departing from the scope and spirit of the invention. Also, descriptions of well-known functions and constructions will be omitted for clarity and conciseness.

Hereinafter, a technique for updating a Media Access Control (MAC) table of a Layer-2 (L2) switch according to handover of a Mobile Terminal (MT) in a broadband wireless communication system will be described. Exemplary embodiments of the present invention assume that the broadband wireless communication system has a 1-tier configuration. Herein, the 1-tier configuration denotes a configuration of access network comprising one hierarchical class. That is, an exemplary embodiment of the present invention will be described on the assumption that Base Stations (BSs) form a 1-tier configuration by being connected through an L2 switch in the broadband wireless communication system.

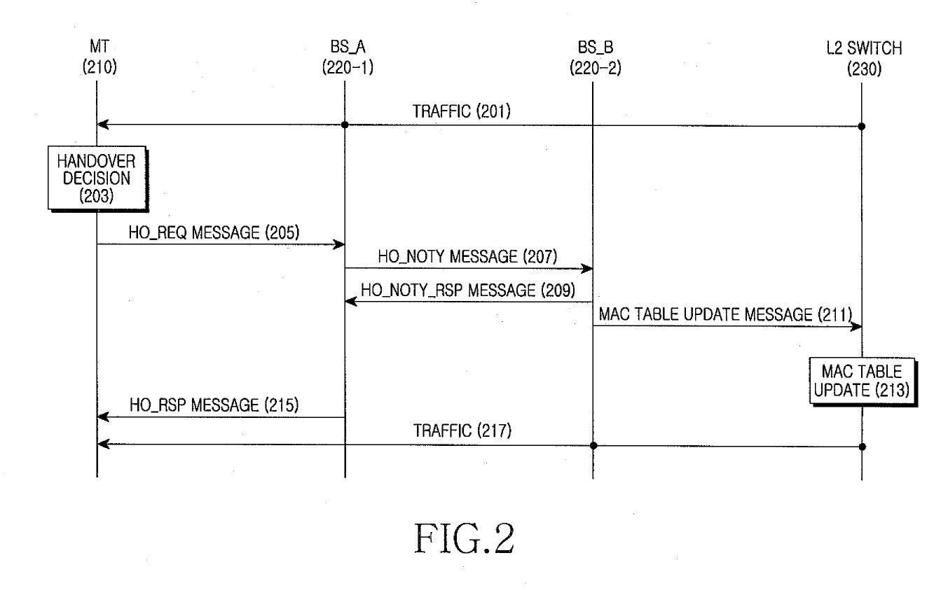

FIG. 2 illustrates a signal exchange for handover in a broadband wireless communication system according to an exemplary embodiment of the present invention. Herein, an L2 switch 230 and a BS_A 220-1 are connected through port 1, and the L2 switch 230 and a BS_B 220-2 are connected through port 2.

Referring to FIG. 2, the L2 switch 230 transmits traffic to an MT 210 through the BS_A 220-1 in step 201. That is, it has been recorded that an output port for downlink traffic of which a destination MAC address is a MAC address of the MT 210 is port 1 in the MAC table of the L2 switch 230.

If the MT 210, which receives the downlink traffic through the BS_A 220-1, detects that the channel quality is getting worse, and determines to perform handover to the BS_B 220-2 in step 203.

The MT 210, which determines to perform handover, transmits a HandOver REQuest (HO_REQ) message to the BS_A 220-1 which is a serving BS in step 205. Wherein, the HO_REQ message includes the MAC address of the MT 210 and information for identifying the BS_B 220-2 which is a target BS.

The BS_A 220-1, which receives the HO_REQ message, confirms the target BS using the HO_REQ message, and transmits a HandOver NOTifY (HO_NOTY) message to the BS_B 220-2 which is the target BS in step 207.

The BS_B 220-2, which receives the HO_NOTY message, determines whether to allow the handover, and transmits a HandOver NOTifY ReSPonse (HO_NOTY_RSP) message to the BS_A 220-1 to inform of the result of the determination in step 209.

The BS_B 220-2, which determines to allow the handover, transmits a MAC table update message to the L2 switch 230 in step 211. Wherein, the MAC table update message includes the MAC address of the MT 210 and is a message for requesting the L2 switch 230 to update the MAC table due to handover.

The L2 switch 230, which receives the MAC table update message, confirms the MAC address of the MT 210 included in the MAC table update message, and updates information on the MT 210 in the MAC table in step 213. In other words, the L2 switch 230 updates information indicating an output port for downlink traffic of which a destination MAC address is a MAC address of the MT 210 from port 1 to port 2. For instance, the MAC table update message is a message comprising only the MAC address of the MT 210 with a size of 6 bytes. In this case, the L2 switch 230 confirms the MAC address of the MT 210, and changes an output port corresponding to the MAC address into a port at which the MAC table update message has been received.

The BS_A 220-1, which receives the HO_NOTY_RSP message, transmits a HandOver ReSPonse (HO_RSP) message to the MT 210 to inform of allowance for the handover in step 215.

The MT 210, which receives the HO_RSP message, access the BS_B 220-2, and the L2 switch 230 outputs downlink traffic according to updated MAC table in step 217. Specifically, the L2 switch 230 outputs downlink traffic of which a destination MAC address is a MAC address of the MT 210 through a port which is connected to the BS_B 220.

According to an exemplary embodiment of the present invention described in FIG. 2, the BS_B 220-2 transmits a MAC table update message to the L2 switch 230. However, according to another exemplary embodiment of the present invention, an Address Resolution Protocol (ARP) is utilized. The ARP is a protocol for obtaining a MAC address. A node, which obtains a MAC address of a counterpart node, transmits an ARP request message to a counterpart node. If the L2 switch 230 receives the ARP request message from the MT 210 through the BS_B 220-2, then the L2 switch 230 recognizes that a serving BS of the MT 220 has been changed. In accordance with another exemplary embodiment of the present invention, the BS_B 220-2 transmits an ARP request message to the L2 switch 230. That is, the BS_B 220-2 generates and transmits the ARP request message as the MT 210 transmits. In this case, although the L2 switch 230 does not apply to an exemplary embodiment of the present invention, the MAC table shall be updated.

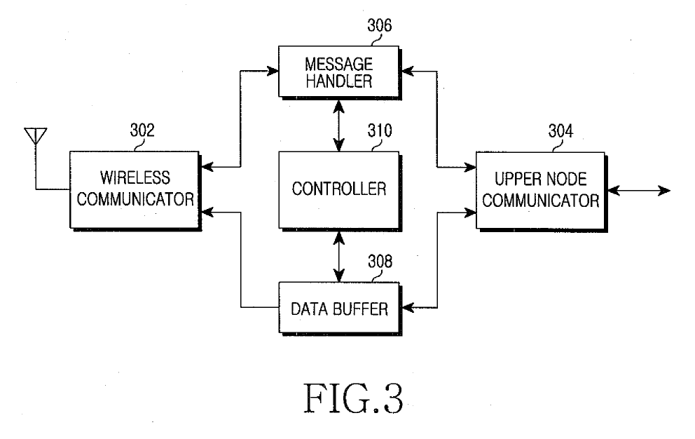

FIG. 3 is a block diagram of a BS in a broadband wireless communication system according to an exemplary embodiment of the present invention.

Referring to FIG. 3, the BS comprises a wireless communicator 302, an upper node communicator 304, a message handler 306, a data buffer 308, and a controller 310.

The wireless communicator 302 converts information bit streams into signals and transmits the signals through an antenna. Also, the wireless communicator 302 converts signals received through the antenna into information bit streams. For instance, in case of using OFDM scheme, the wireless communicator 302 converts the information bit streams into coded bit streams by channel coding, and converts the coded bit streams into complex symbols by modulation. After that, the wireless communicator 302 maps the complex symbols to subcarriers, generates OFDM symbols by an Inverse Fast Fourier Transform (IFFT) operation, up-converts the OFDM symbols into Radio Frequency (RF) signals, and transmits the RF signal through the antenna.

The upper node communicator 304 performs a function of converting between information bit streams and signals to communicate with the upper node, that is, L2 switch. The message handler 306 generates and analyzes messages exchanged with the MT and the L2 switch. The data buffer 308 temporarily saves traffic data exchanged with the MT. The controller 310 controls overall functions of the BS to transmit downlink traffic to the MT and to transmit uplink traffic to the L2 switch. For instance, the controller 310 determines whether to accept an entry of the MT by handover, and controls signaling for the handover.

An operation of the BS according to an exemplary embodiment of the present invention is described hereafter as follows. When the MT enters the BS from an adjacent BS by handover, the controller 310 determines whether to allow an entry of the MT. If the entry is allowed, the controller 310 controls the message handler 306 to generate a MAC table update message. Accordingly, the message handler 306 generates the MAC table update message, and the upper node communicator 304 transmits the MAC table update message to the L2 switch. Wherein, the MAC table update message is a message for requesting to update the MAC table and includes a MAC address of the MT. According to another exemplary embodiment of the present invention, the message handler 306 generates an ARP request message, and the upper node communicator 304 transmits the ARP request message to the L2 switch.

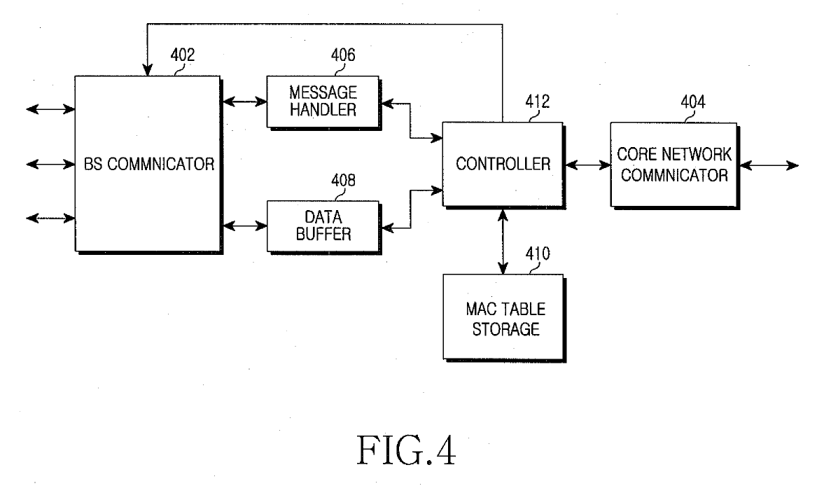

FIG. 4 is a block diagram of an L2 switch in a broadband wireless communication system according to an exemplary embodiment of the present invention.

Referring to FIG. 4, the L2 switch comprises a BS communicator 402, a core network communicator 404, a message handler 406, a data buffer 408, a MAC table storage 410, and a controller 412.

The BS communicator 402 performs a function of converting between information bit streams and signals to communicate with BSs. The BS communicator 402 transmits and receives the signals with a plurality of BSs, and comprises a plurality of ports. Each connection with the BSs is classified by ports. The core network communicator 404 performs a function of converting between information bit streams and signals which is exchanged through a core network (e.g. Ethernet). The message handler 406 analyzes messages received from the BSs. The data buffer 408 temporarily saves traffic data exchanged with the BSs.

The MAC table storage 410 is a memory to store the MAC table indicating output ports for downlink traffic to each MT. The MAC table is managed by the controller 412. The controller 412 controls overall functions of the L2 switch to transmit downlink traffic from the core network to the MT and to transmit uplink traffic from the MT to the core network.

An operation of the L2 switch according to an exemplary embodiment of the present invention is described as follows.

The message handler 406 confirms a MAC address of an MT by analyzing a MAC table update message from a BS. Accordingly, the controller 412 updates information for the MT in a MAC table saved at the MAC table storage 410. That is, the controller 412 updates the information indicating an output port for downlink traffic of which a destination MAC address is a MAC address of the MT to a port at which the MAC table update message has been received. After that, when downlink traffic of which a destination MAC address is a MAC address is received from the core network, the controller 412 controls the BS communicator 402 to output the downlink traffic according to the updated MAC table.

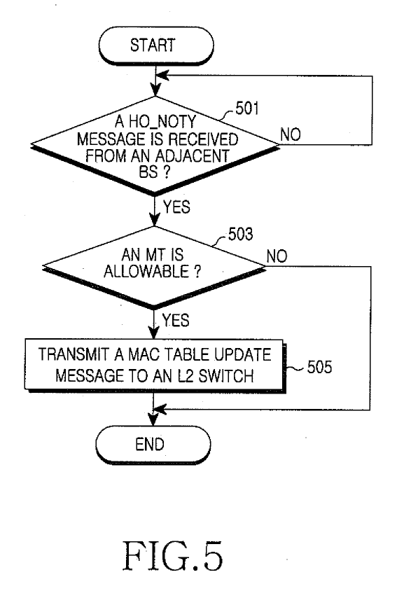

FIG. 5 is a flowchart illustrating a MAC table update request process of a BS in a broadband wireless communication system according to an exemplary embodiment of the present invention.

Referring to FIG. 5, in step 501, the BS determines whether a HO_NOTY message is received from an adjacent BS. That is, the BS determines whether there is an MT, which performs handover from an adjacent BS. Herein, the HO_NOTY message includes a MAC address of the MT.

When the HO_NOTY message is received, the BS determines whether an entry of the MT is allowable in step 503. That is, the BS determines whether to accept a handover request.

When the entry of the MT is allowable, the BS transmits a MAC table update message to an L2 switch in step 505. Wherein, the MAC table update message is a message for requesting to update the MAC table and includes a MAC address of the MT.

Referring again to FIG. 5, the BS transmits a MAC table update message to the L2 switch. According to another exemplary embodiment of the present invention, the BS transmits an ARP request message to the L2 switch in step 505.

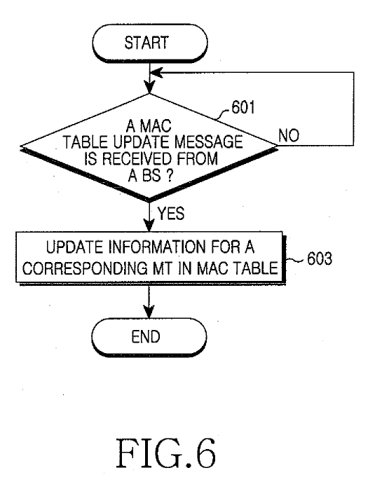

FIG. 6 is a flowchart illustrating a MAC table update process of an L2 switch in a broadband wireless communication system according to an exemplary embodiment of the present invention.

Referring to FIG. 6, the L2 switch determines whether a MAC table update message is received from a BS in step 601. Wherein, the MAC table update message is a message for requesting to update the MAC table and includes a MAC address of the MT.

When the MAC table update message is received, the L2 switch updates information for the MT in the MAC table in step 603. In other words, the L2 switch updates the information indicating an output port for downlink traffic of which a destination MAC address is a MAC address of the MT to a port at which the MAC table update message has been received. Therefore, when the downlink traffic of which a destination MAC address is the MAC address of the MT is received, the L2 switch outputs the downlink traffic to the port at which the MAC table update message has been received.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. An apparatus for a Base Station (BS) in a wireless communication system having a 1-tier configuration and using a Layer-2 (L2) switch, the apparatus comprising:
a controller for determining whether to accept an entry of a mobile terminal (MT) by handover from an adjacent BS;
a handler for generating a Media Access Control (MAC) table update message to get the L2 switch to update a MAC table; and
a communicator for transmitting the MAC table update message to the L2 switch.

2. The apparatus of claim 1, wherein the MAC table update message comprises a MAC address of the MT.

3. The apparatus of claim 2, wherein the MAC table update message comprises a message for requesting the L2 switch to update the MAC table due to handover.

4. The apparatus of claim 2, wherein the MAC table update message comprises an Address Resolution Protocol (ARP) request message.

5. The apparatus of claim 1, wherein the controller receives a HandOver NOTifY (HO_NOTY) message from the adjacent BS before the determining of whether to accept the entry of the MT by handover.

6. The apparatus of claim 1, wherein the communicator transmits a HandOver ReSPonse (HO_RSP) message to the adjacent BS after the transmitting of the MAC table update message.

7. An apparatus for a Layer-2 (L2) switch connecting Base Stations (BSs) in a wireless communication system having a 1-tier configuration, the apparatus comprising:
a communicator for receiving a Media Access Control (MAC) table update message from a BS; and
a controller for updating a MAC table according to the MAC table update message.

8. The apparatus of claim 7, wherein the the MAC table update message comprises a MAC address of a Mobile Terminal (MT).

9. The apparatus of claim 8, wherein the controller updates information on an output port corresponding to the MAC address of the MT to a port at which the MAC table update message has been received.

10. The apparatus of claim 7, wherein the the MAC table update message comprises a message for requesting the L2 switch to update the MAC table due to handover.

11. An operating method of a Base Station (BS) in a wireless communication system having a 1-tier configuration and using a Layer-2 (L2) switch, the method comprising:
determining whether to accept an entry of a mobile terminal (MT) by handover from an adjacent BS;
generating a Media Access Control (MAC) table update message to get the L2 switch to update a MAC table; and
transmitting the MAC table update message to the L2 switch.

12. The method of claim 11, wherein the MAC table update message comprises a MAC address of the MT.

13. The method of claim 12, wherein the MAC table update message comprises a message for requesting the L2 switch to update the MAC table due to handover.

14. The method of claim 12, wherein the MAC table update message comprises an Address Resolution Protocol (ARP) request message.

15. The method of claim 11, further comprising:
receiving a HandOver NOTifY (HO_NOTY) message from the adjacent BS before the determining of whether to accept the entry of the MT by handover.

16. The method of claim 15, wherein the adjacent BS receives a HandOver REQuest (HO_REQ) message from the MT.

17. The method of claim 11, further comprising:
transmitting a HandOver ReSPonse (HO_RSP) message to the adjacent BS after the transmitting of the MAC table update message.

18. An operating method of a Layer-2 (L2) switch connecting Base Stations (BSs) in a wireless communication system having a 1-tier configuration, the method comprising:
receiving a Media Access Control (MAC) table update message from a BS; and
updating a MAC table according to the MAC table update message.

19. The method of claim 18, wherein the the MAC table update message comprises a MAC address of a Mobile Terminal (MT).

20. The method of claim 19, wherein the updating of the MAC table comprises updating information on an output port corresponding to the MAC address of the MT to a port at which the MAC table update message has been received.

21. The method of claim 18, wherein the the MAC table update message is a message for requesting the L2 switch to update the MAC table due to handover.
